(19) United States
(12) Patent Application Publication
(10) Pub. No.: US 2023/0169418 A1
(43) Pub. Date: Jun. 1, 2023

(54) INTELLIGENT INVITATION SYSTEM

(71) Applicant: Citrix Systems, Inc., Ft. Lauderdale, FL (US)

(72) Inventors: Manbinder Pal Singh, Coral Springs, FL (US); Christopher Fleck, Hillsboro Beach, FL (US)

(73) Assignee: Citrix Systems, Inc., Ft. Lauderdale, FL (US)

(21) Appl. No.: 17/457,072

(22) Filed: Dec. 1, 2021

(51) Int. Cl. G06Q 10/06; G06F 40/279; G10L 15/26

(52) U.S. Cl. CPC G06Q 10/06311; G06F 40/279; G10L 15/26

(57) ABSTRACT

A computing device for providing an intelligent invitation system for network-based conversation applications is provided. The computing device includes a computer readable medium and at least one processor operably coupled to the computer readable medium. The at least one processor can be configured to receive conversation information related to a conversation between two or more conversation participants. The processor can analyze the conversation information to identify one or more additional users to invite to the conversation by, for example, performing a speech to text conversion of the conversation information and processing the text for one or more specific keywords that can be used to identify the one or more additional users. The processor can then generate and transmit a notification to at least one of the conversation participants, the notification including information related to the one or more additional users to invite to the conversation.

### BACKGROUND

In network environments, a server can host or provide access to a plurality of resources or applications for a plurality of users. These applications typically include one or more messaging and/or conferencing applications that provide users working in remote locations the opportunity to converse. However, a lack of spontaneity resulting from reductions in casual conversations is a significant employee engagement problem. Conversations that may randomly occur when colleagues interact in an office are generally replaced with structured and scheduled conversations using a conferencing application.

### SUMMARY

In at least one example, a method of providing an intelligent invitation system for a network-based conversation application is provided. The method includes receiving, by a processor, conversation information related to a conversation between a plurality of conversation participants; analyzing, by the processor, the conversation information to identify one or more additional users to invite to the conversation; generating, by the processor, a notification to at least one of the plurality of conversation participants, the notification including information related to the one or more additional users to invite to the conversation; and transmitting, by the processor, the notification to one or more of the at least one of the plurality of conversation participants and the one or more additional users.

Implementations of the method of providing an intelligent invitation system for a network-based conversation application can include one or more of the following features.

In examples of the method, the method can include determining availability information regarding the one or more additional users to invite to the conversation, wherein at least a portion of the notification is based upon the availability information. In some examples, determining the availability information can include determining availability information including information indicating current activity status for the one or more additional users and information indicating whether the one or more additional users are interruptible.

In examples of the method, analyzing the conversation information can include performing a speech to text translation of at least a portion of the conversation information to produce translated conversation text, identifying one or more keywords within the translated conversation text, and determining the one or more additional users to invite to the conversation based upon the one or more keywords. In some examples, identifying the one or more keywords can include identifying one or more of an individual user being discussed, a group of users being discussed, or a subject matter of interest being discussed.

In examples of the method, the method can further include receiving subscription information from the one or more additional users, the subscription information including one or more subject matter keywords, identifying one or more conversation keywords based upon analysis of the conversation information, and comparing the one or more conversation keywords to the one or more subject matter keywords of the subscription information. In some examples, the method can further include sending a subscription notification to at least one of the one or more additional users when at least one of the one or more conversation keywords matches at least one of the one or more subject matter keywords of the subscription information.

In another example, a computing device configured to provide an intelligent invitation system for a network-based conversation application is provided. The computing device includes a computer readable memory, a network interface, and at least one processor operably coupled to the memory and the network interface. The at least one processor can be configured to receive conversation information related to a conversation between a plurality of conversation participants, analyze the conversation information to identify one or more additional users to invite to the conversation, generate a notification to at least one of the plurality of conversation participants, the notification including information related to the one or more additional users to invite to the conversation, and transmit the notification to one or more of the at least one of the plurality of conversation participants and the one or more additional users.

Implementations of the computing device configured to provide an intelligent invitation system for a network-based conversation application can include one or more of the following features.

In examples of the computing device, the at least one processor can be further configured to determine availability information regarding the one or more additional users to invite to the conversation, wherein at least a portion of the notification is based upon the availability information. In some examples, the at least one processor being configured to determine the availability information ca include the at least one processor being configured to determine availability information including information indicating current activity status for the one or more additional users and information indicating whether the one or more additional users are interruptible.

In examples of the computing device, the at least one processor being configured to analyze the conversation information can include the at least one processor being configured to perform a speech to text translation of at least a portion of the conversation information to produce translated conversation text, identify one or more keywords within the translated conversation text, and determine the one or more additional users to invite to the conversation based upon the one or more keywords. In some examples, the at least one processor being configured to identify the one or more keywords can include the at least one processor being configured to identify one or more of an individual user being discussed, a group of users being discussed, or a subject matter of interest being discussed.

In examples of the computing device, the at least one processor can be further configured to receive subscription information from the one or more additional users, the subscription information including one or more subject matter keywords, identify one or more conversation keywords based upon analysis of the conversation information, compare the one or more conversation keywords to the one or more subject matter keywords of the subscription information, and send a subscription notification to at least one of the one or more additional users when at least one of the one or more conversation keywords matches at least one of the one or more subject matter keywords of the subscription information.

In examples of the computing device, the at least one processor being configured to analyze the conversation information can include the at least one processor being configured to perform a speech to text translation of at least a portion of the conversation information to produce translated conversation text, input the translated conversation test to a language model to generate a modeled conversation output, and determine the one or more additional users to invite to the conversation based upon the modeled conversation output.

In another examples, a system configured to provide an intelligent invitation system for a network-based conversation application is provided. The system includes a computer readable memory, a network interface operably coupled to a plurality of client computing devices, and at least one processor operably coupled to the memory and the network interface. The at least one processor can be configured to receive subscription information from at least one of the plurality of client computing devices, receive conversation information related to a conversation between a plurality of conversation participants, analyze the conversation information to generate analyzed conversation information, identify one or more conversation keywords based upon the analyzed conversation information, compare the one or more conversation keywords to the one or more subject matter keywords of the subscription information, and send a subscription notification to the at least one of the plurality of client computing devices when at least one of the one or more conversation keywords matches at least one of the one or more subject matter keywords of the subscription information.

Implementations of the system configured to provide an intelligent invitation system for a network-based conversation application can include one or more of the following.

In examples of the system, the at least one processor being configured to analyze the conversation information can include the at least one processor being configured to perform a speech to text translation of at least a portion of the conversation information to produce translated conversation text and identify the one or more conversation keywords within the translated conversation text. In some examples, the at least one processor being configured to identify the one or more conversation keywords can include the at least one processor being configured to identify one or more of an individual user being discussed, a group of users being discussed, or a subject matter of interest being discussed.

In examples of the system, the at least one processor is further configured to analyze the conversation information to identify one or more additional users to invite to the conversation, generate an invitation notification to at least one of the plurality of conversation participants, the invitation notification including information related to the one or more additional users to invite to the conversation, and transmit the invitation notification to one or more of the at least one of the plurality of conversation participants and the one or more additional users. In some examples, the at least one processor is further configured to determine availability information regarding the one or more additional users to invite to the conversation, wherein at least a portion of the invitation notification is based upon the availability information. In some examples, the at least one processor being configured to determine the availability information can include the at least one processor being configured to determine availability information including information indicating current activity status for the one or more additional users and information indicating whether the one or more additional users are interruptible.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a system architecture for accessing a distributed workspace by multiple client devices.

FIG. 2 is a block diagram of a conversation manager for a remote conversation application system in accordance with an example of the present disclosure.

FIG. 3 is a block diagram of a sample network environment of computing devices in which various aspects of the present disclosure can be implemented.

FIG. 4 is a block diagram of a cloud computing environment in which various aspects of the present disclosure can be implemented.

FIGS. 5A-5C are block diagrams of sample systems in which resource management services can manage and streamline client access to resource feeds, in accordance with an example of the present disclosure.

FIGS. 6A-6C are flow diagrams for providing an intelligent invitation system for a conversation application, in accordance with an example of the present disclosure.

FIGS. 7A and 7B are screenshots of a conversation application using the intelligent invitation system as described herein, in accordance with an example of the present disclosure.

FIG. 8 is a screenshot of a distributed workspace including an invitation to join a conversation, in accordance with an example of the present disclosure.

FIG. 9 is a flow diagram for receiving conversation subscription information, in accordance with an example of the present disclosure.

FIG. 10 is a block diagram of one or more of the computing devices as described herein, in accordance with an example of the present disclosure.

### DETAILED DESCRIPTION

As summarized above, various examples described herein are directed to systems and methods for providing dynamic and intelligent invitations to users to join a conference call or other similar conversation between remote users where the invited user would otherwise generally not be included in the conversation. For example, the systems and methods as described herein monitor user activity between users participating in a remote conversation and provide notifications to the users of additional users that may be able to participate and contribute to the conversation. The systems and methods can be further configured to check availability of the additional users and provide that information as well when providing the notifications.

Current conferencing and/or conversation applications provide and interface for remotely located users to engage in active and real-time communications with coworkers. Typically, these conversation applications are initiated when a first user directly contacts a second user or, in certain examples, when two or more users select a time to schedule a formal conversation session. While providing a beneficial tool for facilitating the real-time communication between coworkers, conversation applications are typically cumbersome when it comes to inviting additional users to participate in an active communication session. For example, the conversation flow is generally interrupted when one or more of the participants of the conversation session attempts to invite an additional user. The inviter generally needs to determine the user's contact information to facilitate creation of an invitation to the user to join the active conversation session. The inviter also generally waits for a response from the invited user which can distract the inviter from the active conversation session. If the invited user is unavailable or uninterruptible, the inviter may wait an extended period of time to receive a notification indicating that the invited user will not be joining the active conversation session. In certain examples, the inviter may never receive an indication that the user is unavailable and may continue to monitor the conversation session for the user to join. Such functionality acts to limit the inviters engagement in the active conversation session during the invitation process. Additionally, the ability to drop in on a conversation or to provide insight into an area a worker may be an expert is generally lost as a result of the structure and scheduled nature of remote conversations.

The systems and methods as described herein overcome the disadvantages and limitations of traditional conversation applications by providing an automatic and intelligent invitation system that monitors conversation activity to automatically determine one or more additional users to invite to a conversation session. Such systems and methods as described herein provide various advantages to improve traditional conversation applications and the user experiences with those conversation applications. By removing the need for a user to determine an additional user to invite to the conversation session and determine contact information for that user, a user's interaction with the conversation application is simplified while providing an improved invitation system for inviting additional users to join the conversation session. For example, if two or more participants in an active conversation are discussing a particular subject, the systems and processes as described herein can automatically identify a subject matter expert related to the subject being discussed. A recommendation can be automatically provided to the participants of the conversation session to invite or otherwise schedule a time to discuss with the identified subject matter expert. In such an example, interruptions to the conversation are minimalized and identification of the additional user is automated such that the user experience with the conversation application is improved.

Thus, and in accordance with at least some examples disclosed herein, intelligent invitation systems and methods for network-based communication applications are provided. These systems and methods enhance the quality of a user's experience with a conversation application by providing in automatic and intelligent invitation system for identifying and inviting additional users to participate in an active conversation session while reducing the required input from participants of the active conversation session to invite the additional users.

Some examples include a computing device for providing an intelligent invitation system for network-based conversation applications. The computing device includes a computer readable medium and at least one processor operably coupled to the computer readable medium. The at least one processor can be configured to receive conversation information related to a conversation between two or more conversation participants. The processor can analyze the conversation information to identify one or more additional users to invite to the conversation by, for example, performing a speech to text conversion of the conversation information and processing the text for one or more specific keywords that can be used to identify the one or more additional users. The processor can then generate and transmit a notification to at least one of the conversation participants, the notification including information related to the one or more additional users to invite to the conversation. In some additional examples as described herein, the processor can determine whether a user to be invited is uninterruptible or otherwise unavailable to join. In such an example, the notification can include additional options and/or recommendations for scheduling a meeting with the user to be invited at a future time.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Sample Computing Systems

In some examples, a distributed system is configured to implement workspace and system access to remote users, thereby providing a central repository of applications, files, and other similar resources to a group of trusted users accessible via, for example, an enterprise service. A distributed workspace can be implemented as a software framework designed to deliver and manage a user's applications, data, and desktops in a consistent and secure manner, regardless of the user's device or location. Distributed workspaces enhance the user experience by streamlining and automating those tasks that a user performs frequently, such as approving expense reports, confirming calendar appointments, submitting helpdesk tickets, and reviewing vacation requests. A distributed workspace allows users to access functionality provided by multiple enterprise applications—including software as a system (SaaS) applications, web applications, desktop applications, and proprietary applications—through a single interface.

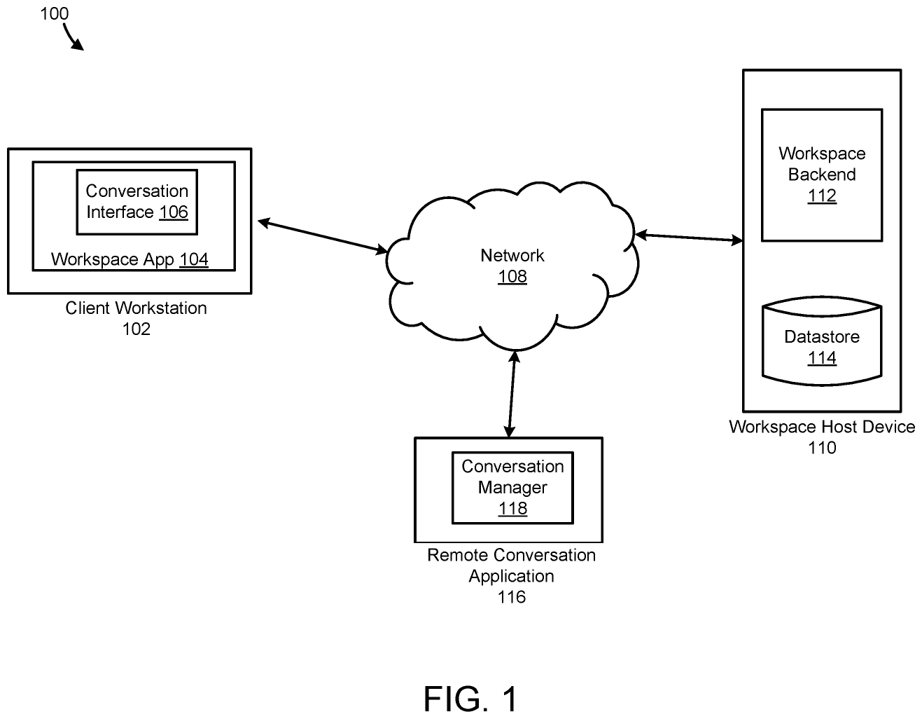

FIG. 1 illustrates a logical architecture of one implementation of, for example, a distributed workspace system 100 that is configured to connect one or more client computing devices with one or more remote computing devices configured to host shared resources such as applications accessible via the distributed workspace. As shown in FIG. 1, the system 100 can include a client device 102. As further shown in FIG. 1, client devices 102 can include a workspace application 104. The workspace application 104 can be configured to provide an interface to facilitate remote access to one or more resources hosted at or by, for example, a remote computing device such as workspace host device 110. In certain implementations, the client device 102 can be operably connected to the remote computing device via one or more networks 108. In some examples, the network 108 can be a wired network, a wireless network, or a combination of both wired and wireless networks.

In some examples, the workspace host device 110 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol (HTTP) client; a File Transfer Protocol (FTP) client; an Oscar client; a Telnet client; or any other set of executable instructions.

In some examples, the workspace host device 110 can execute a remote presentation services program or other program that uses a thin client or a remote-display protocol to capture display output generated by an application executing on the remote computing device and transmit the application display output to the client device 102 for presentation to one or more device users.

In some examples, the workspace host device 110 can include a server agent that is configured to communicate with the workspace application 104. The server agent can be configured to, for example, authenticate a client device, provide secure access to one or more remote and/or shared resources, monitor user interactions with the resources, update user access based upon changes to user permission levels for a client device, distribute or properly direct requests to available resources, and perform other similar distributed workspace functions.

In yet other examples, the workspace host device 110 can be configured to execute a virtual machine providing access to a computing environment to a user of client device 102. The virtual machine can be managed by, for example, a hypervisor, a virtual machine manager (VMM), or any other hardware virtualization technique within the workspace host device 110.

In some examples, the network 108 can be: a local area network (LAN); a metropolitan area network (MAN); a wide area network (WAN); a primary public network; and a primary private network. Additional examples can include a network 108 of mobile telephone networks that use various protocols to communicate among mobile devices. For short range communications within a wireless local-area network (WLAN), the protocols can include 802.11, Bluetooth, and Near Field Communication (NFC).

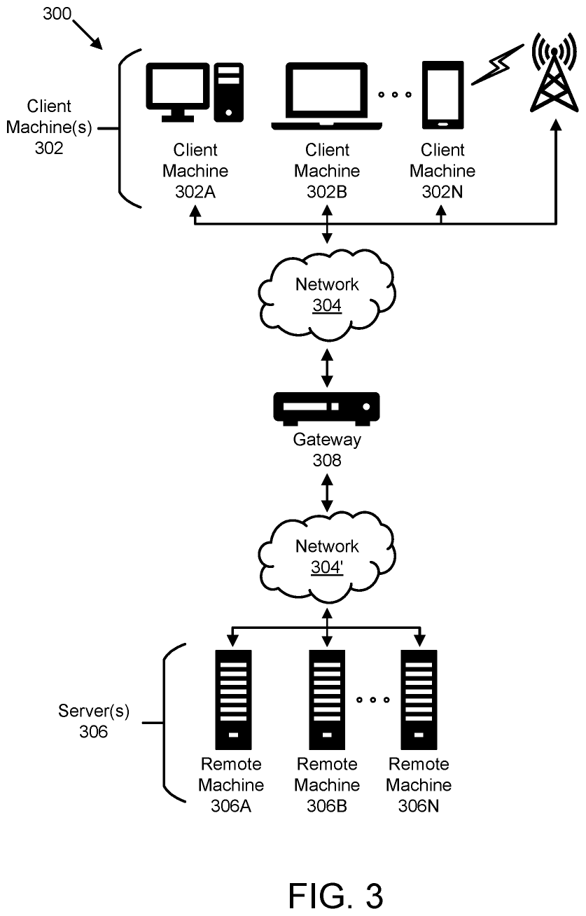

It should be noted that the specific device architecture as shown in FIG. 1 is provided by way of example only. For instance, in certain implementations, multiple remote computing devices can be operably connected to the client devices via, for example, one or more network appliances configured to perform, for example, access control and load balancing. Additional network examples and associated devices are described below in the discussion of FIG. 3.

In a typical distributed workspace, a user of the client device 102 can access a conferencing or conversation application interface 106 through, for example, workspace application 104. For example, the user can organize scheduled conversations and/or conferences with other users of the distributed workspace system 100 using the conversation application interface 106.

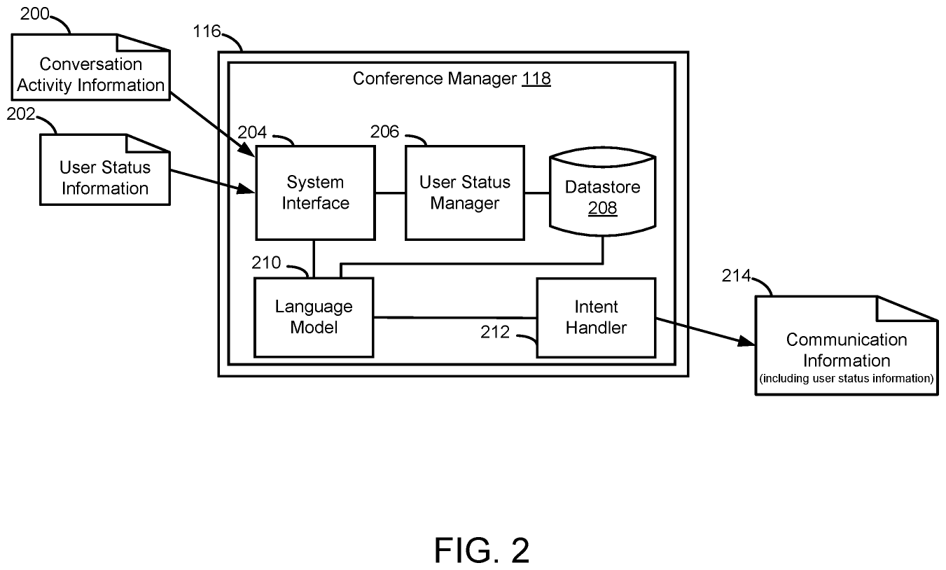

As noted above, to further process messaging application information, the distributed workspace system 100 can include a remote conversation application system 116. As further shown in FIG. 1, the remote conversation application system 116 can include a conversation manager 118. The conversation manager 118 can be configured to monitor user activity at, for example, the client device 102 as well as process conversation application information transmitted throughout the distributed workspace system 100. FIG. 2 Illustrates a detailed view of the conversation application system 116 and the conversation manager 118. For example, as shown in FIG. 2, the conversation application system 116 can be configured to receive both conversation activity information 200 and user status information 202. The conversation manager 118 can include a system interface 204 configured to receive and process incoming data such as user activity information 200 and user status information 202. The system interface 204 can process the conversation activity information 200 and the user status information 202. In some examples, the system interface 204 can be configured to process and pass the user status information 202 to a user status manager 206. The user status manager 206 can be configured to analyze the user status information 202 and determine various information related to a user of a distributed workspace as described herein. For example, user status manager 206 can determine information such as user contact information, subject matter expertise information for the user, availability and/or interruptibility information for the user, and other similar user information from the user status information 202. In certain implementations, a processor as described herein can implement the user status manager 206 as a series of API calls for transmitting requests to one or more information sources and receiving information in response to the requests.

As further shown in FIG. 2, the user status manager 206 can be operably coupled to a datastore 208. The user status manager 206 can be configured to store at least a portion of the user status information 202 in the datastore 208 as, for example, historic user information, for later processing.

The system interface 204 can also be operably coupled to language model 210. The language model 210 can be configured to receive information from the system interface 204 such as the conversation activity information 200, process the information, and generate output information for additional processing. For example, the language model 210 can be configured to receive analyzed conversation information including one or more subjects of interest as included in a monitored conversation from the system interface 204. The language model 210 can be configured to analyze the subjects of interest information and determine, for example, one or more subject matter experts from the information included in datastore 208. In some examples, the language model 210 can include a keyword analyzer that is configured to process the conversation activity information 200 or one or more keyword strings. Based upon identification of the keyword strings, the language model can format the information for additional processing as described herein. In certain implementations, the language model 210 can include a natural language processor. The natural language process can be a trained model configured to monitor the conversation activity information 200 to analyze for human language patterns and identify user intent within the information.

In certain implementations, the language model 210 can be operably coupled to an intent handler 212. The intent handler 212 can be configured to process information received from the language model 210, generate an appropriate response, output communication information 214 as described herein to one or more devices within the distributed workspace system 100. In certain implementations as described herein, the intent handler 212 can be configured to generate an additional notification to one or more participants of a remote conversation. The additional notification can include a prompt to invite one or more additional participants to the remote conversation as described herein.

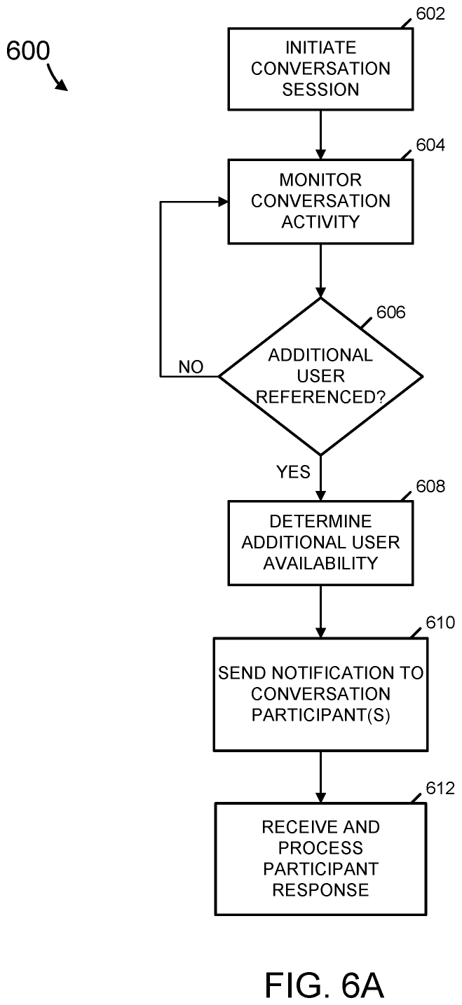

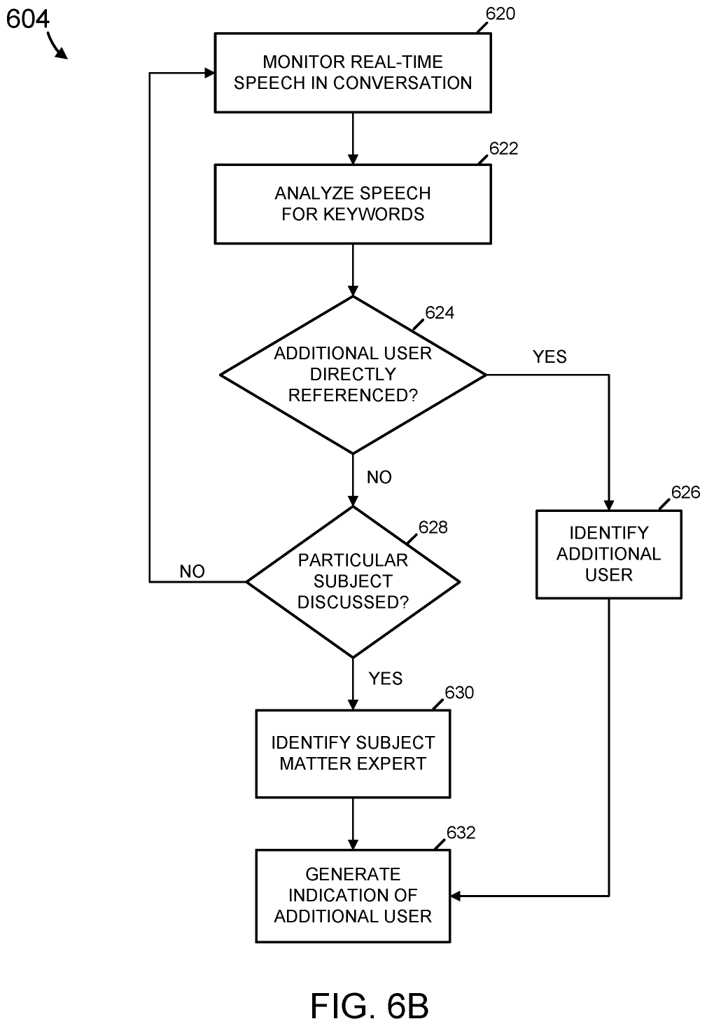

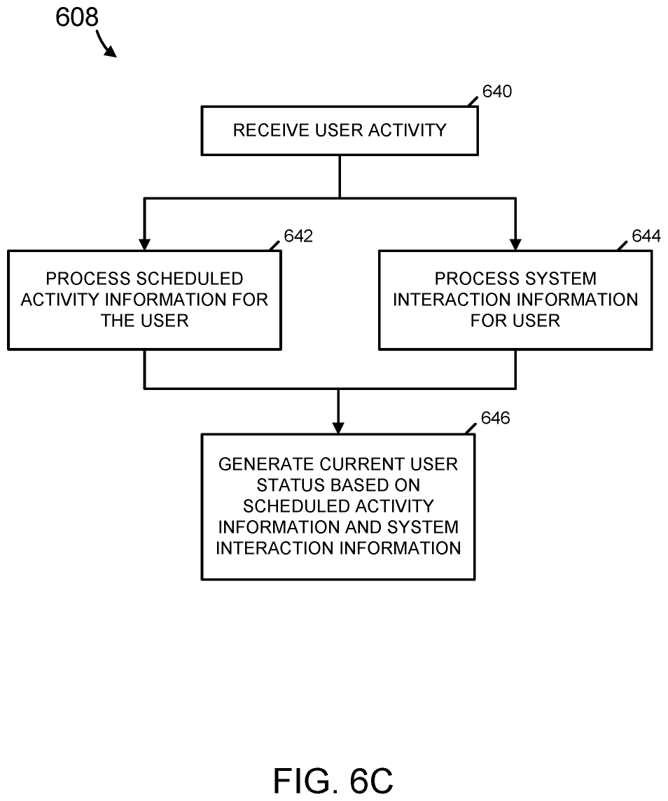

For example, the system interface 204 can receive a communication request to establish a communication session between a first client and a second client within the distributed workspace system 100. The language model 210 can process the received communication request, communicate with the intent handler 212 to generate a response to the communication request, and the conference manager 118 can output a response to the communication request as, for example, communication information 214. During the conversation, the system interface 204 can continue to monitor and analyze the conversation activity information 200. Based upon this analysis, the system interface 204 can determine whether one or more additional users are being discussed or referred to during the conversation. The user status manager 206 and the language model 210 can further process this information to determine if the users being referred to are available. Based upon the determination, the intent handler 212 can provide a notification to the participants of the conversation, the notification including an option to invite the additional users as described hereinbelow. As such, the conversation application system 116 as described herein and shown in FIGS. 1 and 2 can be configured to monitor and analyze conversation information to determine one or more recommended users to join the conversation. The conversation application system 116 can further provide a notification to one or more participants of the conversation of the recommended users. Additional detail related to the functionality of, for example, a remote conversation application and a related conversation manager as shown in FIGS. 1 and 2 is provided in the discussion of FIGS. 6A-9 below.

As noted above in FIG. 1, various computing devices can be arranged into one or more interconnected networks to provide user access to remote resources through various client devices. Referring to FIG. 3, a non-limiting network environment 300 provides an alternative arrangement to network 100 as shown in FIG. 1, in which various aspects of the disclosure can be implemented. As shown in FIG. 3, the environment 300 includes one or more client machines 302A-302N, one or more remote machines 306A-306N, one or more networks 304, 304′, and one or more appliances 308 installed within the computing environment 300. The client machines 302A-302N communicate with the remote machines 306A-306N via the networks 304, 304′. The computing environment 300 can also be referred to as a distributed computer system.

In some examples, the client machines 302A-302N communicate with the remote machines 306A-306N via an intermediary appliance 308. The illustrated appliance 308 is positioned between the networks 304, 304′ and can also be referred to as a network interface or gateway. In some examples, the appliance 308 can operate as a remote computing device configured to provide clients with access to business applications and other data deployed in a datacenter, the cloud, or delivered as SaaS applications across a range of client devices, and/or provide other functionality such as load balancing, etc. In some examples, multiple appliances 308 can be used, and the appliance(s) 308 can be deployed as part of the network 304 and/or 304′.

The client machines 302A-302N can be generally referred to as client machines 302, local machines 302, clients 302, client nodes 302, client computers 302, client devices 302, computing devices 302, endpoints 302, or endpoint nodes 302. In certain implementations, client machines 302 can include, for example, client device 102 as shown in FIG. 1 and described above.

The remote machines 306A-306N can be generally referred to as servers 306 or a server farm 306. In some examples, a client device 302 can have the capacity to function as both a client node seeking access to resources provided by a server 306 and as a server 306 providing access to hosted resources for other client devices 302A-302N. The networks 304, 304′ can be generally referred to as a network 304. The networks 304 can be configured in any combination of wired and wireless networks.

A server 306 can be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing a directory service; a cloud server; or a server executing an application acceleration program that provides firewall functionality, application functionality, or load balancing functionality. In some examples, a server 306 can include the functionality of the workspace host device 110 as shown in FIG. 1 and described above.

A server 306 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol client; a File Transfer Protocol client; an Oscar client; a Telnet client; or any other set of executable instructions.

In some examples, a server 306 can execute a remote presentation services program or other program that uses a thin client or a remote-display protocol to capture display output generated by an application executing on a server 306 and transmit the application display output to a client device 302.

In yet other examples, a server 306 can execute a virtual machine providing, to a user of a client device 302, access to a computing environment. The client device 302 can be a virtual machine. The virtual machine can be managed by, for example, a hypervisor, a virtual machine manager (VMM), or any other hardware virtualization technique within the server 306.

In some examples, the network 304 can be: a LAN; a MAN; a WAN; a primary public network; and a primary private network. Additional examples can include a network 304 of mobile telephone networks that use various protocols to communicate among mobile devices. For short range communications within a WLAN, the protocols can include 802.11, Bluetooth, and NFC. In certain examples, the network 304 can include network 108 as shown in FIG. 1 and described above.

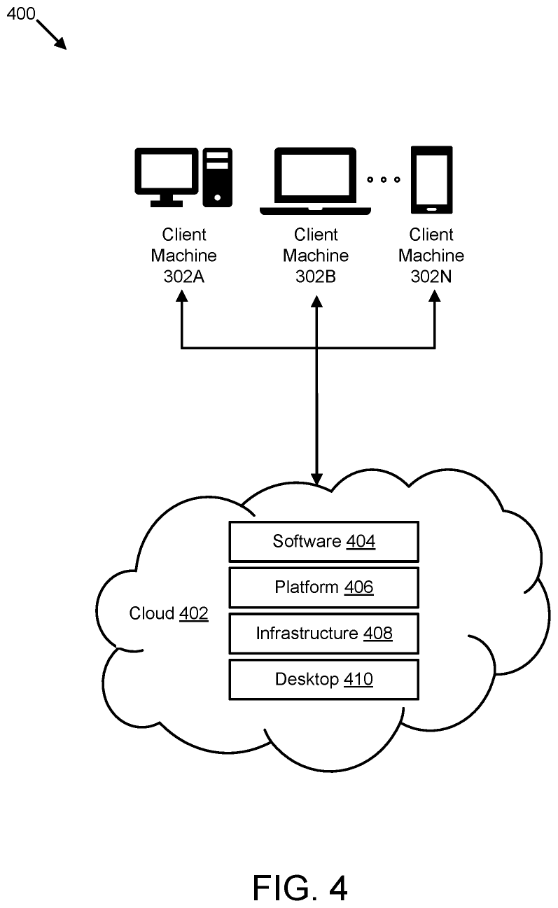

Referring to FIG. 4, a cloud computing environment 400 is depicted, which can also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and processing time.

In the cloud computing environment 400, one or more clients 302a-302n (such as those described above and shown in FIG. 3) are in communication with a cloud network 402. The cloud network 402 can include back-end platforms, e.g., servers, storage, server farms or data centers. The users or clients 302a-302n can correspond to a single organization/tenant or multiple organizations/tenants. More particularly, in one example implementation the cloud computing environment 400 can provide a private cloud serving a single organization (e.g., enterprise cloud). In another example, the cloud computing environment 400 can provide a community or public cloud serving multiple organizations/tenants.

In some examples, a gateway appliance(s) or service can be utilized to provide access to cloud computing resources and virtual sessions. By way of example, Citrix Gateway, provided by Citrix Systems, Inc., can be deployed on-premises or on public clouds to provide users with secure access and single sign-on to virtual, SaaS and web applications. Furthermore, to protect users from web threats, a gateway such as Citrix Secure Web Gateway can be used. Citrix Secure Web Gateway uses a cloud-based service and a local cache to check for uniform resource locator (URL) reputation and category.

In still further examples, the cloud computing environment 400 can provide a hybrid cloud that is a combination of a public cloud and a private cloud. Public clouds can include public servers that are maintained by third parties to the clients 302a-302n or the enterprise/tenant. The servers can be located off-site in remote geographic locations or otherwise.

The cloud computing environment 400 can provide resource pooling to serve multiple users via clients 302a-302n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some implementations, the cloud computing environment 400 can provide on-demand self-service to unilaterally provision computing capabilities (e.g., server time, network storage) across a network for multiple clients 302a-302n. By way of example, provisioning services can be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 302. In some examples, the cloud computing environment 400 can include or provide monitoring services to monitor, control and/or generate reports corresponding to the provided shared services and resources.

In some implementations, the cloud computing environment 400 can provide cloud-based delivery of different types of cloud computing services, such as SaaS 404, Platform as a Service (PaaS) 406, Infrastructure as a Service (IaaS) 408, and Desktop as a Service (DaaS) 410, for example. IaaS can refer to a user renting the use of infrastructure resources that are needed during a specified time period. IaaS providers can offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers can offer functionality provided by IaaS, including, e.g., storage, networking, servers, or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers can offer the resources that PaaS provides, including storage, networking, servers, virtualization, operating system, middleware, or runtime resources. In some examples, SaaS providers can offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS can also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms can be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace application can be used as a single-entry point for bringing apps, files and desktops together (whether on-premises or in the cloud) to deliver a unified experience.

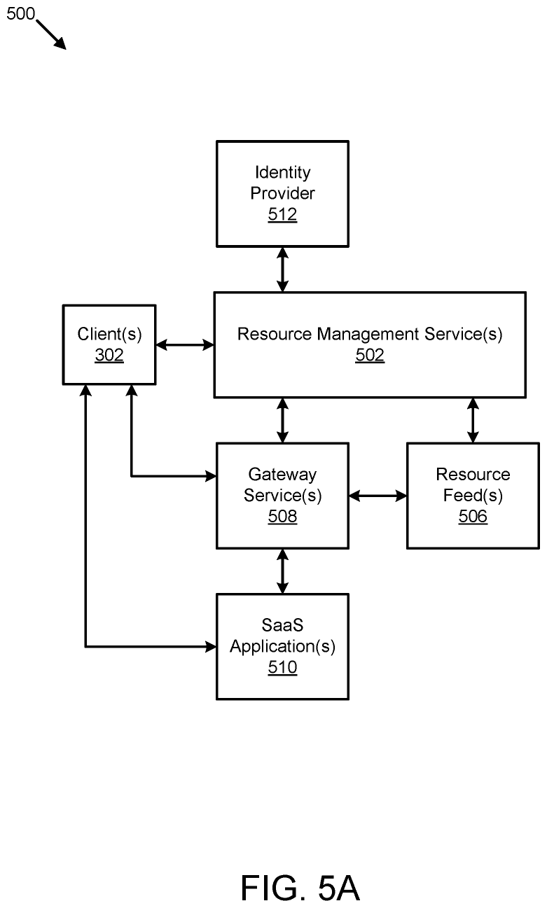

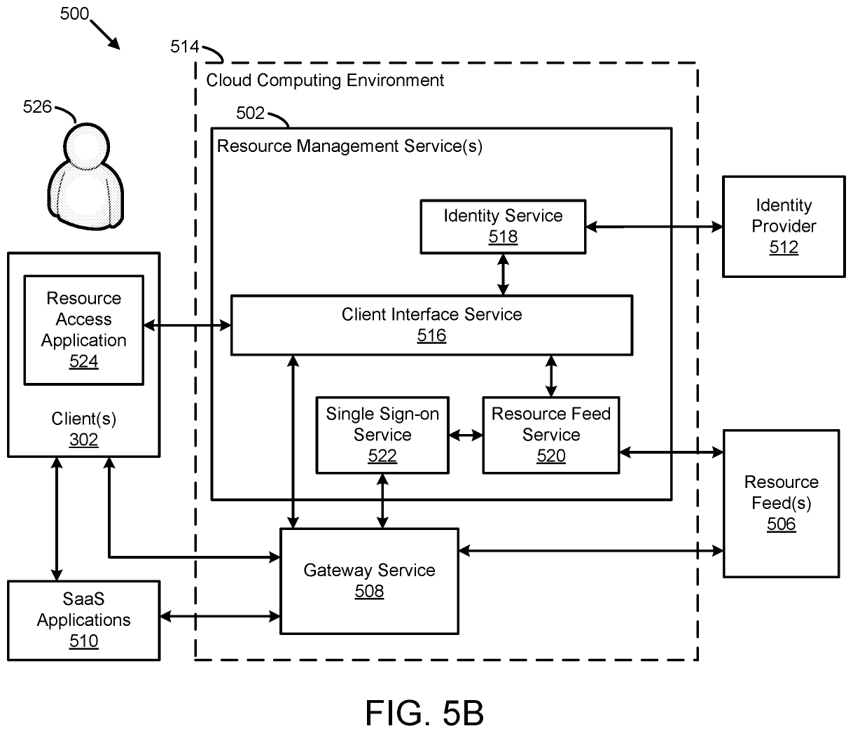

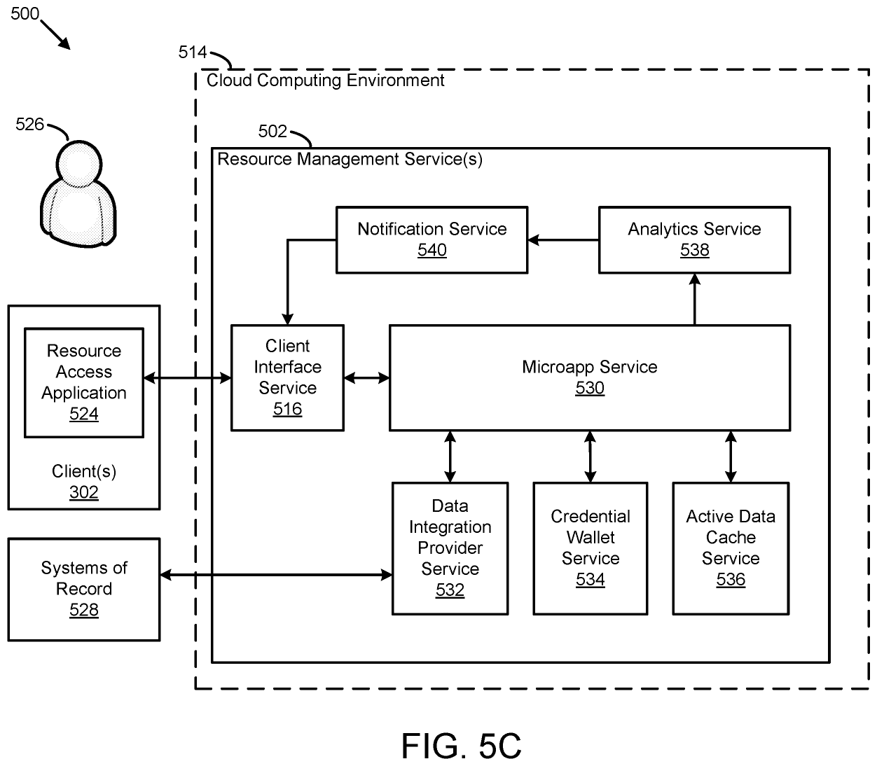

FIG. 5A is a block diagram of an example system 500 in which one or more resource management services 502 can manage and streamline access by one or more clients 302 to one or more resource feeds 506 (via one or more gateway services 508) and/or one or more SaaS applications 510. In particular, the resource management service(s) 502 can employ an identity provider 512 to authenticate the identity of a user of a client 302 and, following authentication, identify one or more resources the user is authorized to access. In response to the user selecting one of the identified resources, the resource management service(s) 502 can send appropriate access credentials to the requesting client 302, and the client 302 can then use those credentials to access the selected resource. For the resource feed(s) 506, the client 302 can use the supplied credentials to access the selected resource via a gateway service 508. For the SaaS application(s) 510, the client 302 can use the credentials to access the selected application directly.

The client(s) 302 can be any type of computing devices capable of accessing the resource feed(s) 506 and/or the SaaS application(s) 510, and can, for example, include a variety of desktop or laptop computers, smartphones, tablets, etc. The resource feed(s) 506 can include any of numerous resource types and can be provided from any of numerous locations. In some implementations, for example, the resource feed(s) 506 can include one or more systems or services for providing virtual applications and/or desktops to the client(s) 302, one or more file repositories and/or file sharing systems, one or more secure browser services, one or more access control services for the SaaS applications 510, one or more management services for local applications on the client(s) 302, one or more internet enabled devices or sensors, etc. Each of the resource management service(s) 502, the resource feed(s) 506, the gateway service(s) 508, the SaaS application(s) 510, and the identity provider 512 can be located within an on-premises data center of an organization for which the system 500 is deployed, within one or more cloud computing environments, or elsewhere.

FIG. 5B is a block diagram showing an example implementation of the system 500 shown in FIG. 5A in which various resource management services 502 as well as a gateway service 508 are located within a cloud computing environment 514. The cloud computing environment can, for example, include Microsoft Azure Cloud, Amazon Web Services, Google Cloud, or IBM Cloud.

For any of illustrated components (other than the client 302) that are not based within the cloud computing environment 514, cloud connectors (not shown in FIG. 5B) can be used to interface those components with the cloud computing environment 514. Such cloud connectors can, for example, run on Windows Server instances hosted in resource locations and can create a reverse proxy to route traffic between the site(s) and the cloud computing environment 514. In the illustrated example, the cloud-based resource management services 502 include a client interface service 516, an identity service 518, a resource feed service 520, and a single sign-on service 522. As shown, in some examples, the client 302 can use a resource access application 524 to communicate with the client interface service 516 as well as to present a user interface on the client 302 that a user 526 can operate to access the resource feed(s) 506 and/or the SaaS application(s) 510. The resource access application 524 can either be installed on the client 302, or can be executed by the client interface service 516 (or elsewhere in the system 500), and accessed using a web browser (not shown in FIG. 5B) on the client 302.

As explained in more detail below, in some examples, the resource access application 524 and associated components can provide the user 526 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data. For example, as described herein, the resource application 524 can include some or all of the functionality of the messaging application system 116 and/or the state manager 118 as shown in FIG. 1 and described above.

When the resource access application 524 is launched or otherwise accessed by the user 526, the client interface service 516 can send a sign-on request to the identity service 518. In some implementations, the identity provider 512 can be located on the premises of the organization for which the system 500 is deployed. The identity provider 512 can, for example, correspond to an on-premises Windows Active Directory. In such examples, the identity provider 512 can be connected to the cloud-based identity service 518 using a cloud connector (not shown in FIG. 5B), as described above. Upon receiving a sign-on request, the identity service 518 can cause the resource access application 524 (via the client interface service 516) to prompt the user 526 for the user's authentication credentials (e.g., user-name and password). Upon receiving the user's authentication credentials, the client interface service 516 can pass the credentials along to the identity service 518, and the identity service 518 can, in turn, forward them to the identity provider 512 for authentication, for example, by comparing them against an Active Directory domain. Once the identity service 518 receives confirmation from the identity provider 512 that the user's identity has been properly authenticated, the client interface service 516 can send a request to the resource feed service 520 for a list of subscribed resources for the user 526.

In other examples (not illustrated in FIG. 5B), the identity provider 512 can be a cloud-based identity service, such as a Microsoft Azure Active Directory. In such implementations, upon receiving a sign-on request from the client interface service 516, the identity service 518 can, via the client interface service 516, cause the client 302 to be redirected to the cloud-based identity service to complete an authentication process. The cloud-based identity service can then cause the client 302 to prompt the user 526 to enter the user's authentication credentials. Upon determining the user's identity has been properly authenticated, the cloud-based identity service can send a message to the resource access application 524 indicating the authentication attempt was successful, and the resource access application 524 can then inform the client interface service 516 of the successful authentication. Once the identity service 518 receives confirmation from the client interface service 516 that the user's identity has been properly authenticated, the client interface service 516 can send a request to the resource feed service 520 for a list of subscribed resources for the user 526.

For each configured resource feed, the resource feed service 520 can request an identity token from the single sign-on service 522. The resource feed service 520 can then pass the feed-specific identity tokens it receives to the points of authentication for the respective resource feeds 506. Each resource feed 506 can then respond with a list of resources configured for the respective identity. The resource feed service 520 can then aggregate all items from the different feeds and forward them to the client interface service 516, which can cause the resource access application 524 to present a list of available resources on a user interface of the client 302. The list of available resources can, for example, be presented on the user interface of the client 302 as a set of selectable icons or other elements corresponding to accessible resources. The resources so identified can, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 302, and/or one or more SaaS applications 510 to which the user 526 has subscribed. The lists of local applications and the SaaS applications 510 can, for example, be supplied by resource feeds 506 for respective services that manage which such applications are to be made available to the user 526 via the resource access application 524. Examples of SaaS applications 510 that can be managed and accessed as described herein include Microsoft Office 365 applications, SAP SaaS applications, Workday applications, etc.

For resources other than local applications and the SaaS application(s) 510, upon the user 526 selecting one of the listed available resources, the resource access application 524 can cause the client interface service 516 to forward a request for the specified resource to the resource feed service 520. In response to receiving such a request, the resource feed service 520 can request an identity token for the corresponding feed from the single sign-on service 522. The resource feed service 520 can then pass the identity token received from the single sign-on service 522 to the client interface service 516 where a launch ticket for the resource can be generated and sent to the resource access application 524. Upon receiving the launch ticket, the resource access application 524 can initiate a secure session to the gateway service 508 and present the launch ticket. When the gateway service 508 is presented with the launch ticket, it can initiate a secure session to the appropriate resource feed and present the identity token to that feed to seamlessly authenticate the user 526. Once the session initializes, the client 302 can proceed to access the selected resource.

When the user 526 selects a local application, the resource access application 524 can cause the selected local application to launch on the client 302. When the user 526 selects a SaaS application 510, the resource access application 524 can cause the client interface service 516 to request a one-time URL from the gateway service 508 as well a preferred browser for use in accessing the SaaS application 510. After the gateway service 508 returns the one-time URL and identifies the preferred browser, the client interface service 516 can pass that information along to the resource access application 524. The client 302 can then launch the identified browser and initiate a connection to the gateway service 508. The gateway service 508 can then request an assertion from the single sign-on service 522. Upon receiving the assertion, the gateway service 508 can cause the identified browser on the client 302 to be redirected to the logon page for identified SaaS application 510 and present the assertion. The SaaS can then contact the gateway service 508 to validate the assertion and authenticate the user 526. Once the user has been authenticated, communication can occur directly between the identified browser and the selected SaaS application 510, thus allowing the user 526 to use the client 302 to access the selected SaaS application 510.

In some examples, the preferred browser identified by the gateway service 508 can be a specialized browser embedded in the resource access application 524 (when the resource application is installed on the client 302) or provided by one of the resource feeds 506 (when the resource application 524 is located remotely), e.g., via a secure browser service. In such examples, the SaaS applications 510 can incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 302 such that the watermark will appear as displayed on the screen if the user tries to print or take a screenshot. Further, in some implementations, when a user selects a hyperlink within a SaaS application, the specialized browser can send the URL for the link to an access control service (e.g., implemented as one of the resource feed(s) 506) for assessment of its security risk by a web filtering service. For approved URLs, the specialized browser can be permitted to access the link. For suspicious links, however, the web filtering service can have the client interface service 516 send the link to a secure browser service, which can start a new virtual browser session with the client 302, and thus allow the user to access the potentially harmful linked content in a safe environment.

In some examples, in addition to or in lieu of providing the user 526 with a list of resources that are available to be accessed individually, as described above, the user 526 can instead be permitted to choose to access a streamlined feed of event notifications and/or available actions that can be taken with respect to events that are automatically detected with respect to one or more of the resources. This streamlined resource activity feed, which can be customized for each user 526, can allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed can be accompanied by a discrete set of user-interface elements, e.g., “approve,” “deny,” and “see more detail” buttons, allowing a user to take one or more simple actions with respect to each event right within the user's feed. In some implementations, such a streamlined, intelligent resource activity feed can be enabled by one or more micro-applications, or “microapps,” that can interface with underlying associated resources using, for example, application programming interfaces (APIs) or the like. The responsive actions can be user-initiated activities that are taken within the microapps and that provide inputs to the underlying applications through the API or other interface. The actions a user performs within the microapp can, for example, be designed to address specific common problems and use cases quickly and easily, adding to increased user productivity (e.g., request personal time off, submit a help desk ticket, etc.). In some examples, notifications from such event-driven microapps can additionally or alternatively be pushed to clients 302 to notify a user 526 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 528 labeled “systems of record,” and further in which several different services are included within the resource management services block 502. As explained below, the services shown in FIG. 5C can enable the provision of a streamlined resource activity feed and/or notification process for a client 302. In the example shown, in addition to the client interface service 516 discussed above, the illustrated services include a microapp service 530, a data integration provider service 532, a credential wallet service 534, an active data cache service 536, an analytics service 538, and a notification service 540. In various implementations, the services shown in FIG. 5C can be employed either in addition to or instead of the different services shown in FIG. 5B.

In some examples, a microapp can be a single use case made available to users to streamline functionality from complex enterprise applications. Microapps can, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps can streamline routine tasks for frequently performed actions and provide users the ability to perform actions within the resource access application 524 without having to launch the native application. The system shown in FIG. 5C can, for example, aggregate relevant notifications, tasks, and insights, and thereby give the user 526 a dynamic productivity tool. In some implementations, the resource activity feed can be intelligently populated by utilizing machine learning and artificial intelligence (AI) algorithms. Further, in some implementations, microapps can be configured within the cloud computing environment 514, thus giving administrators a powerful tool to create more productive workflows, without the need for additional infrastructure. Whether pushed to a user or initiated by a user, microapps can provide short cuts that simplify and streamline key tasks that would otherwise require opening full enterprise applications. In some examples, out-of-the-box templates can allow administrators with API account permissions to build microapp solutions targeted for their needs. Administrators can also, in some implementations, be provided with the tools they need to build custom microapps.

Referring to FIG. 5C, the systems of record 528 can represent the applications and/or other resources the resource management services 502 can interact with to create microapps. These resources can be SaaS applications, legacy applications, or homegrown applications, and can be hosted on-premises or within a cloud computing environment. A microapp page builder can, for example, connect to legacy, on-premises, and SaaS systems to create streamlined user workflows via microapp actions. The resource management services 502, and in particular the data integration provider service 532, can, for example, support REST API, JSON, OData-JSON, and 6ML. As explained in more detail below, the data integration provider service 532 can also write back to the systems of record, for example, using OAuth2 or a service account.

In some examples, the microapp service 530 can be a single-tenant service responsible for creating the microapps. The microapp service 530 can send raw events, pulled from the systems of record 528, to the analytics service 538 for processing. The microapp service can, for example, periodically pull active data from the systems of record 528.

In some examples, the active data cache service 536 can be single-tenant and can store all configuration information and microapp data. It can, for example, utilize a pertinent database encryption key and per-tenant database credentials.

In some examples, the credential wallet service 534 can store encrypted service credentials for the systems of record 528 and user OAuth2 tokens.

In some examples, the data integration provider service 532 can interact with the systems of record 528 to decrypt end-user credentials and write back actions to the systems of record 528 under the identity of the end-user. The write-back actions can, for example, utilize a user's actual account to ensure all actions performed are compliant with data policies of the application or other resource being interacted with.

In some examples, the analytics service 538 can process the raw events received from the microapps service 530 to create targeted scored notifications and send such notifications to the notification service 540.

Finally, in some examples, the notification service 540 can process any notifications it receives from the analytics service 538. In some implementations, the notification service 540 can store the notifications in a database to be later served in a notification feed. In other implementations, the notification service 540 can additionally or alternatively send the notifications out immediately to the client 302 as a push notification to the user 526.

In some implementations, a process for synchronizing with the systems of record 528 and generating notifications can operate as follows. The microapp service 530 can retrieve encrypted service account credentials for the systems of record 528 from the credential wallet service 534 and request a sync with the data integration provider service 532. The data integration provider service 532 can then decrypt the service account credentials and use those credentials to retrieve data from the systems of record 528. The data integration provider service 532 can then stream the retrieved data to the microapp service 530. The microapp service 530 can store the received systems of record data in the active data cache service 536 and also send raw events to the analytics service 538. The analytics service 538 can create targeted scored notifications and send such notifications to the notification service 540. The notification service 540 can store the notifications in a database to be later served in a notification feed and/or can send the notifications out immediately to the client 302 as a push notification to the user 526.

In some implementations, a process for processing a user-initiated action via a microapp can operate as follows. The client 302 can receive data from the microapp service 530 (via the client interface service 516) to render information corresponding to the microapp. The microapp service 530 can receive data from the active data cache service 536 to support that rendering. The user 526 can invoke an action from the microapp, causing the resource access application 524 to send that action to the microapp service 530 (via the client interface service 516). The microapp service 530 can then retrieve from the credential wallet service 534 an encrypted Oauth2 token for the system of record for which the action is to be invoked and can send the action to the data integration provider service 532 together with the encrypted Oath2 token. The data integration provider service 532 can then decrypt the Oath2 token and write the action to the appropriate system of record under the identity of the user 526. The data integration provider service 532 can then read back changed data from the written-to system of record and send that changed data to the microapp service 530. The microapp service 532 can then update the active data cache service 536 with the updated data and cause a message to be sent to the resource access application 524 (via the client interface service 516) notifying the user 526 that the action was successfully completed.

### Sample Process Examples

FIG. 6A illustrates a sample process 600 for providing intelligent invitation information to one or more users of a remote conversation application such as the conferencing and conversation applications as described herein. The process 600 as shown in FIG. 6A can be implemented, for example, by a processor of a computing device such as the workspace host device 110 and/or the remote conversation application system 116 as shown in FIG. 1.

As shown in FIG. 6A, the process 600 can include initiating 602 a conversation session between two or more participants using, for example, a conversation application as described herein. For example, to initiate 602 the conversation session, the processor can receive an indication that at least one of the participants of the conversation has access the conversation application and submitted a request to begin the conversation. In such an example, the processor can launch a conversation session including the requesting participants and any other participants who have requested to access the conversation session via the conversation application. Depending upon the number of potential participants, the processor can further receive additional requests from additional participants to join the conversation session after launching.

Once initiated, the processor can monitor 604 conversation activity. For example, the processor can utilize a speech to text process configured to monitor and record conversation dialogue between the participants of the conversation session. For example, the processor can use one or more machine learning models such as a dialog flow model (such as a natural language processor) to process and analyze the conversation dialogue between the participants of the conversation session as described herein. In certain implementations, the dialog flow model can be used to identify a specific string of text such as an intent to invite an additional user. For example, the dialog flow model can be trained to recognize keyword phrases such as “I wish Joe Smith was on the call,” “we should invite Joe Smith,” “should we invite Joe Smith,” and other similar phrases. Similarly, the dialog flow model can be trained to recognize keywords related to a specific topic being discussed. For example, the model can be trained to recognize “we need help with workspace integration,” “who knows a lot about web development,” “our new project is about improving remote access security,” and other similar phrases related to a specific topic.

FIG. 6B illustrates a more detailed process for monitoring 604 the conversation activity as described herein. As shown in FIG. 6B, the processor can monitor 620 the real-time speech in the conversation and, as described above, convert the speech to text using a real-time speech to text converter. The processor can analyze 622 the converted speech for one or more keywords. For example, as described above, the keywords can relate to a specific person or user being discussed in the conversation session, a specific topic being discussed in the conversation session, or other similar keywords. The processor can process the analyzed keyword to determine 624 if an additional user is directly referenced. For example, if a participant in the conversation session has directly identified another user by name, the processor can determine 624 that additional user has been directly referenced within the conversation session. If the processor determines 624 that an additional user has been directly referenced within the conversation session, the processor can identify 626 the additional user. For example, the processor can access a directory service associated with a company or group to which the participants of the conversation session belong to identify 626 the additional user based upon the information extracted from the analyzed keywords.

Conversely, if the processor does not determine 624 that an additional user has been directly referenced, the processor can continue to analyze the keywords to determine 628 if a particular subject is being discussed in the conversation session. If the processor does not determine 628 that a particular subject is being discussed, the processor can continue to monitor 620 the real-time speech in the conversation session. However, if the processor does determine 628 that a particular subject is being discussed, the processor can process the one or more keywords as determined to be related to the subject being discussed and identify 630 one or more subject matter experts related to the subject being discussed. For example, the processor can check a knowledge graph associated with the company or a group to which the participants of the conversation session belong to determine one or more subject matter experts related to the subject being discussed. For example, the processor can use a Graph API (e.g., an API that models data in terms of nodes and edges and provides for client interaction with multiple nodes in a single request) or other similar API call to identify a person with skills and experience in the subject being discussed. Once the processor has either identified 626 the additional user being discussed in the conversation session, or identified 630 the subject matter related to a subject being discussed within the conversation session, the processor can generate 632 an indication of the additional user for further processing.

Referring back to FIG. 6A, the processor can determine 606 whether an additional user has been referenced or otherwise identified during the conversation session. For example, using a similar process to the determination steps as shown in FIG. 6B and described above, the processor can determine 606 whether the monitored conversation activity indicates an additional user being referenced wither through keyword identification (e.g., referred to by name) or through context identification (e.g., being a subject matter expert in a subject being discussed in the conversation). If, based upon the analysis of the monitored conversation information, the processor determines 606 than an additional user has not been referenced, the processor can continue to monitor 604 the conversation activity. Conversely, if the processor does determine 606 that an additional user has been referenced, the processor can determine 608 availability information for the additional user. For example, the user availability information can include information related to current activity status for the additional user, future activity information for the additional user, and other information that may be used to determine the current user status and availability for the additional user.

As described herein, various processes can be used to determine is a user is available and/or interruptible. FIG. 6C illustrates a sample process that can be used to determine 608 user availability. For example, as shown in FIG. 6C, the processor can receive 640 user activity information related to user engagement with one or more applications within the distributed workspace system as described herein as well as scheduled user information from, for example, a calendar application or other similar time management application. The processor can process 642 scheduled activity information for the user. In certain implementations, the scheduled activity information for the user can include, for example, meeting information extracted or otherwise received from a calendar application or other similar scheduling application. In some examples, the meeting information can also include specific details such as time, location, participant information, meeting notes and other relevant materials for the meeting, and other similar meeting information.

As further shown in FIG. 6C, the processor can also process 644 system interaction information for the user. In certain implementations, the system interaction information can include, for example, one or more applications the user is currently interacting with, the type of interaction the user is performing, keyboard and/or other similar input device activity associated with the user, duration of time the user has been accessing the application, another similar system interaction information. Based upon the scheduled activity information and system interaction information, the processor can generate 646 the current user status for the user, the current user status indicative of the availability of the user to participate in, for example, a communications session associated with one or more conversation applications as described herein.

In some examples the processor can use a trained machine learning classifier (e.g., implemented as the language model 210 as shown in FIG. 2 and described above) to generate 646 the current user status. For example, the machine learning classifier can use historic user data collected from previous user sessions in which the user interacts with one or more messaging applications. Information collected during those sessions, including, for example, scheduled activity information and system interaction information as described above, can be labeled for use as training and verification data, and the recorded outputs of the user's activity can be used as expected outputs for the training and verification data. The machine learning classifier can then be trained and verified using the training and verification data for the user. Once trained and verified, the processor can access the machine learning classifier to generate 646 user status based upon newly received scheduled activity information and system interaction information as described above.

In other examples, the processor can use a rule set for generating 646 the current user status. For example, the rule set can include a rule defining that when the user is accessing a particular application (e.g., the application is the active window in the user's workspace) and the user's keyboard is active (e.g., more than 30 keypresses detected per minute), the user is determined to be busy and uninterruptable. In such an example, the processor can generate 646 the current user status based upon an analysis of the received scheduled activity information and the determined system interaction information for the user according to the defined rule set as described herein.

It should be noted that the sample process as shown in FIG. 6C for determining user availability information is provided by way of example only. As noted above, additional disclosure related to determining user availability is provided in the '295 Application.

Referring back to FIG. 6A, the processor can send 610 a notification of a potential additional user to invite to the conversation to one or more of the conversation participants. For example, the notification can include the additional user's name, contact information, availability information, subject matter expertise information, and/or any other additional information related to the identified additional user. In certain implementations, the notification can be sent 610 to each participant in a conversation, to the specific person addressing or otherwise mentioning the person to be invited, to the organizer/original scheduler of the meeting, or other combinations of active participants within the conversation session. The processor can further receive 612 and process a conversation participant's response to the sent notification.

It should be noted that sample process 600, and the expanded process flows for process steps 604 and 608 as shown in FIGS. 6B and 6C respectively, are provided by way of example only. Depending upon the implementation of the systems and processes as described herein, the process steps as shown in FIGS. 6A through 6C can be altered accordingly.

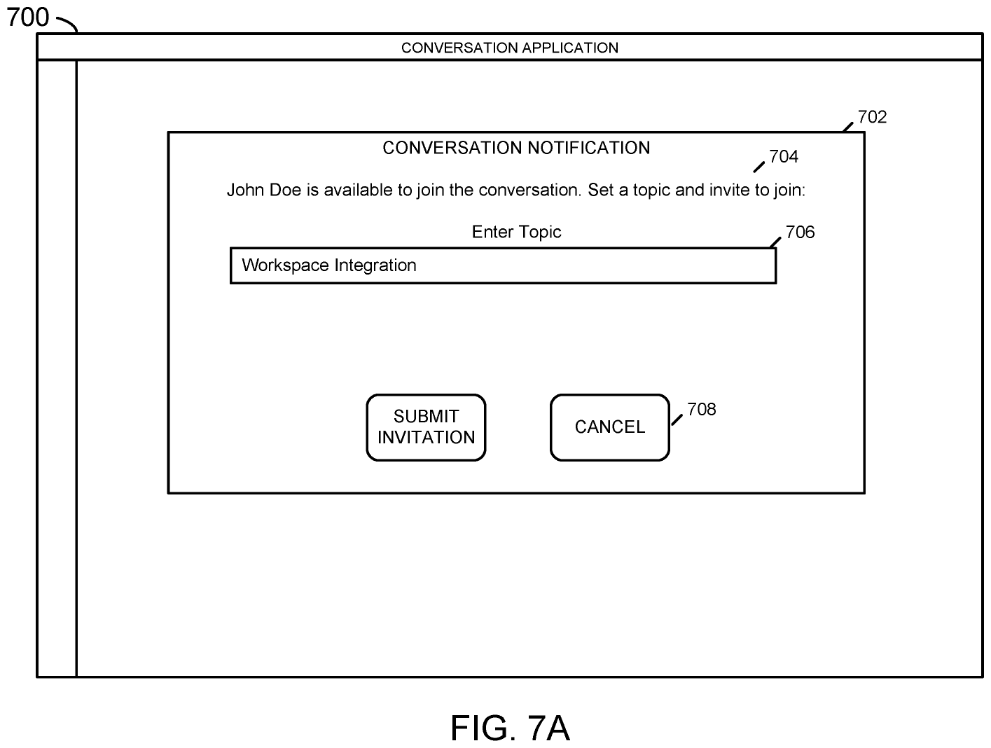

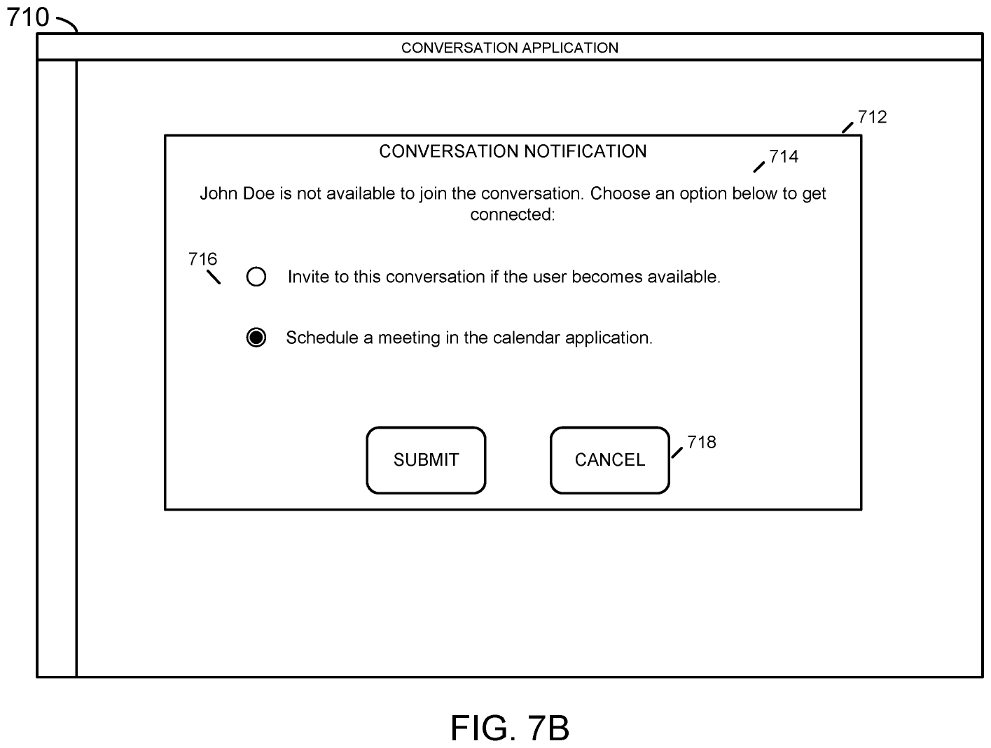

As described above in FIG. 6A, one or more participants in a conversation session can receive a notification of an additional user to invite to participate in the conversation session as well. FIG. 7A illustrates a sample view of a user interface screen 700 that can be displayed during a conversation session using a conversation application as described herein. As shown in FIG. 7A, the user interface screen 700 is displaying a conversation notification 702 of an additional user to invite to the conversation session.

More specifically, the conversation notification 702 can include user information 704 related to the user to invite. For example, as shown in information 704, user John Doe is currently available to join and active conversation session. The conversation notification 702 can further include user interface controls 706 and 708. For example, the user interface control 706 can include a user accessible input configured to receive user provided information related to a topic being discussed during the conversation. For example, as shown in FIG. 7A, the user interface control 706 has been updated to indicate that the topic of discussion during the conversation session is “workspace integration.” The user interface controls 708 can include an option for a conversation participant to submit an invitation to the additional user or to cancel the invitation altogether. Based upon the information as entered within the notification window 702, a processor as described herein and associated with the conversation application can receive the entered topic as entered in user face control 706. The processor can further receive an instruction to either submit the invitation to the additional user or cancel the invitation as indicated by the user selection of user interface control 708.

As noted above, the notification sent to participants of a conversation can be updated based upon the availability information for an additional user to invite to the conversation session. FIG. 7B illustrates a sample view of a user interface screen 710 that can be displayed during a conversation session using a conversation application as described here in. However, unlike user interface screen 700 as shown in FIG. 7A and described above, in the example as shown in FIG. 7B, the additional user to invite is currently unavailable and/or uninterruptible.

As shown in FIG. 7B, the user interface screen 710 can display a conversation notification 712 of an additional user to invite to the conversation session. The conversation notification 712 can include user information 714 related to the user to invite. In this example, as shown in information 714, user John Doe is currently not available to join the conversation. The participants of the conversation session are further prompted to choose an option to potentially connect with the additional user, in this example, John Doe. For example, the conversation notification 712 can further include user interface controls 716 and 718. For example, the user interface controls 716 can include one or more user-selectable options for following up with John Doe. For example, as shown in FIG. 7B, the user interface control 716 can include an option to invite the additional user to the conversation if the user becomes available. Upon selection of this option, the processor can receive instructions to continually monitor the availability information for the additional user and, if the user becomes available, provide an invitation to join the conversation session to that user. As further shown in FIG. 7B, the user interface control 716 can include an option to schedule a meeting using, for example, a calendar application. Upon selection of this option, the processor can launch a session of the calendar application and, in certain implementations, prepopulate a meeting request with information related to the conversation session, the names of the conversation participants, and the name of the additional user identified to join. The user interface controls 718 can include an option for a conversation participant to submit their selection to the processor for further processing or to cancel the invitation altogether. Based upon the information has entered within the notification window 702, the user selection as made using interface control 716, and the user selection of user interface control 718, the processor can further process the received information accordingly.

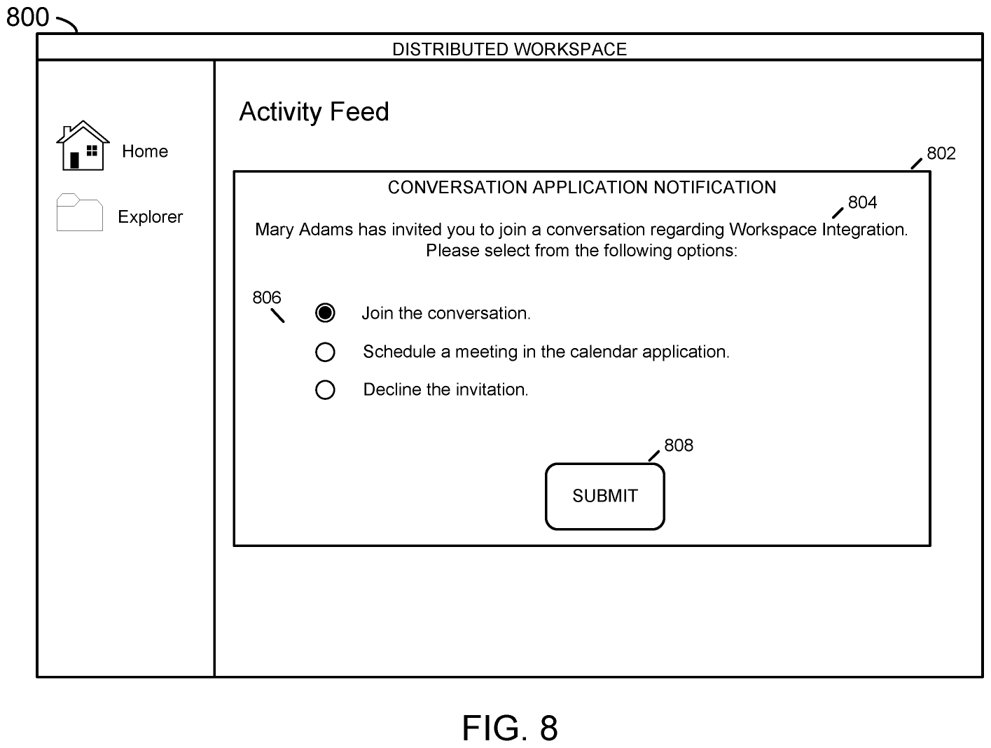

If a participant of an active conversation session does opt to invite an additional user to join the conversation session, the processor as described herein can process the invitation and send a notification to the additional user as described herein. FIG. 8 illustrates a user interface screen 800 displaying digital workspace session for an example additional user being invited to join a conversation session.

For example, the user interface screen 800 can update to display a conversation notification 802. The conversation notification 802 can include information 804 listing additional information related to the conversation invitation. For example, as shown in FIG. 8, the information 804 includes the name of the person inviting the additional user to join the conversation and topic information related to the active conversation session. As further shown in FIG. 8, the additional user can access one or more user interface controls 806 and 808 to further process the invitation. In certain implementations, the user interface control 806 can include one or more user-selectable options for generating a response to the invitation. For example, the user interface control 806 can include a user-selectable option to join the conversation, schedule a meeting in the calendar application, or decline the invitation. The additional user can access user control 808 to submit their selection as indicated in the user interface control 806.

Upon submission of the user selection, the processor can receive an indication of the user selection as entered in user interface control 806 and further process the response accordingly. For example, if the additional user has provided an indication that they wish to join the conversation, the processor can launch an instance of the conversation application and use a system call such as supported by the workspace backend to join the additional user in the conversation session. In another example, if the additional user has provided an indication that they would like to schedule a meeting in the calendar application for a later time, the processor can launch an instance of the calendar application and, in certain implementations, prepopulate a meeting request with information related to the conversation session.

The systems and processes as described above provide for a dynamic and intelligent invitation system that can allow participants in an active conversation session to invite additional users to join the conversation session without interrupting workflow. For example, rather than stop a conversation while contact information is searched for to invite an additional user, the processes as described above provide for an automatic and intelligent invitations system for inviting additional users to join a conversation session. Additionally, by providing availability information, active participants in a conversation session are immediately notified of the additional users' availability and may avoid wasting time waiting for a response from the additional user as to whether the additional user will join the active conversation session.

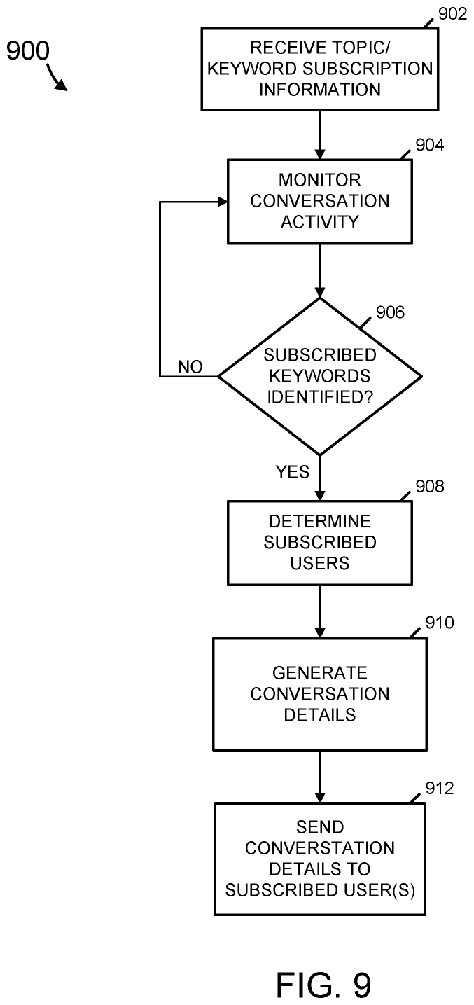

However, the systems and processes as described above are generally directed towards providing additional user functionality to active participants in a conversation session. FIG. 9 illustrates a process 900 to provide added user functionality to users that are not currently participating in an active conversation session. For example, when a user is in the office and interacting with their coworkers, the ability to overhear a conversation and drop in based upon the subject matter being discussed in the conversation can lead to improved coworker relationships and provide beneficial information related to people working on a particular project. However, such spontaneous conversation activity is lost when workers move to a remote working environment. The process 900 as shown in FIG. 9 provides for a subscription model where users can subscribe to particular keywords that may be associated with one or more active conversation sessions. When an active conversation session is directed toward the one or more subscribed keywords, the subscribed user can receive a notification of the active conversation session and be prompted with information related to joining the conversation.

More specifically, as shown in FIG. 9, a processor of a computing device such as the workspace host device 110 and or the remote conversation application system 116 as shown in FIG. 1 can be configured to implement the process 900. The process 900 can include receiving 902 topic and keyword subscription information from one or more users in a distributed workspace as described herein. The processor can monitor 904 conversation activity for all active conversation sessions as managed by the conversation application as described herein. The processor can identify keywords as included in the active conversation sessions as described above and determine 906 whether any identified keywords match any subscribed keywords as provided by the subscribed users. Similarly, as described above, a trained language model such as a natural language processor can determine intent or context within a conversation session. The determined intent and/or context can also be compared against the subscribed keywords to determine any matches.

For example, the processor can compare each identified keyword against a listing of the subscribed keywords to determine one or more matches for each active conversation session as described herein. If the processor does not determine 906 that there are any identified subscribed keywords in any active conversation sessions, the processor can continue to monitor 904 the conversation activity. If, conversely, the processor does determine 906 that one or more subscribed keywords match one or more identified keywords in the conversation activity, the processor can determine 908 one or more subscribed users associated with the matched keywords. The processor can generate 910 one or more notifications including conversation details related to the active conversation session and send 912 the one or more notifications to the subscribed users. The subscribed users can then access the notification and the included conversation details to determine whether they want to join and or otherwise participate in the active conversation session.

### Hardware Implementation Examples

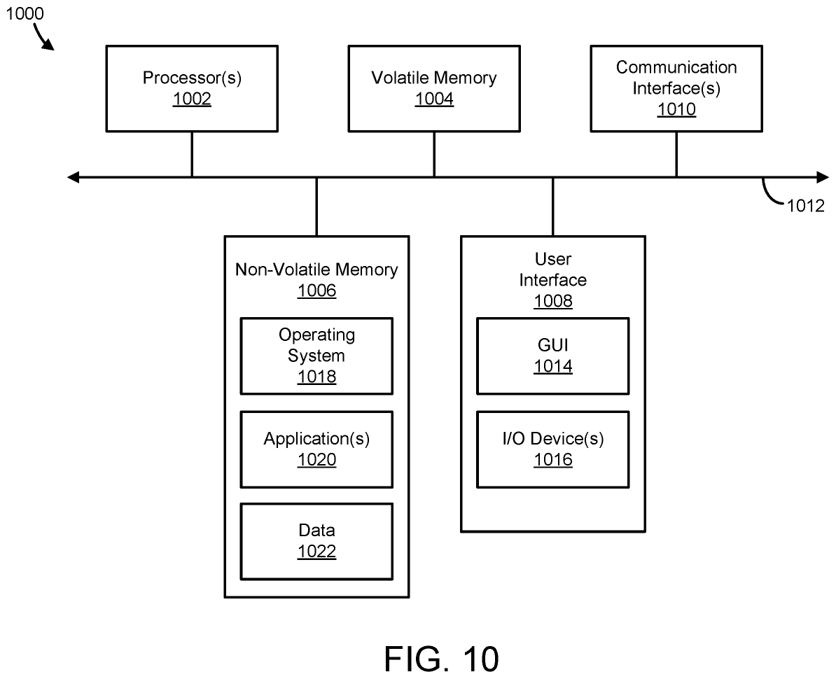

FIG. 10 depicts a block diagram of a computing device 1000 useful for practicing an example of client device 102 and/or workspace host device 110 as shown in FIG. 1 and described above. The computing device 1000 includes one or more processors 1002, volatile memory 1004 (e.g., random access memory (RAM)), non-volatile (non-transitory) memory 1006, UI 1008, one or more communications interfaces 1010, and a communications bus 1012. One or more of the computing devices 1000 can also be referred to as a computer system.

The non-volatile memory 1006 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 1008 can include a graphical user interface (GUI) 1014 (e.g., a touchscreen, a display, etc.) and one or more input/output (I/O) devices 1016 (e.g., a mouse, a keyboard, a microphone, one or more speakers, one or more cameras, one or more biometric scanners, one or more environmental sensors, and one or more accelerometers, etc.).

The non-volatile memory 1006 can store an operating system 1018, one or more applications 1020, and data 1022 such that, for example, computer instructions of the operating system 1018 and/or the applications 1020 are executed by processor(s) 1002 out of the volatile memory 1004. In some examples, the volatile memory 1004 can include one or more types of RAM and/or a cache memory that can offer a faster response time than a main memory. Data can be entered using an input device of the GUI 1014 or received from the I/O device(s) 1016. Various elements of the computing device 1000 can communicate via the communications bus 1012.

The illustrated computing device 1000 is shown merely as an example client device or server and can be implemented by any computing or processing environment with any type of machine or set of machines that can have suitable hardware and/or software capable of operating as described herein.

The processor(s) 1002 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 1002 can be analog, digital or mixed. In some examples, the processor 1002 can include multiple processor cores and/or multiple processors configured to provide functionality for parallel, simultaneous execution of instructions or for parallel, simultaneous execution of one instruction on more than one piece of data.

The communications interfaces 1010 can include one or more interfaces to enable the computing device 1000 to access a computer network such as a Local Area Network (LAN), a Wide Area Network (WAN), a Personal Area Network (PAN), or the Internet through a variety of wired and/or wireless connections, including cellular connections.

In described examples, the computing device 1000 can execute an application on behalf of a user of a client device (e.g., client device 102 as shown in FIG. 1 and described above). For example, the computing device 1000 can execute one or more virtual machines managed by a hypervisor and accessed via, for example, a client agent. Each virtual machine can provide an execution session within which applications execute on behalf of a user or a client device, such as a hosted desktop session. The computing device 1000 can also execute a terminal services session to provide a distributed workspace environment. The computing device 1000 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A method of providing an intelligent invitation system for a network-based conversation application, the method comprising:
receiving, by a processor, conversation information related to a conversation between a plurality of conversation participants;
analyzing, by the processor, the conversation information to identify one or more additional users to invite to the conversation;
generating, by the processor, a notification to at least one of the plurality of conversation participants, the notification comprising information related to the one or more additional users to invite to the conversation; and
transmitting, by the processor, the notification to one or more of the at least one of the plurality of conversation participants and the one or more additional users.

2. The method of claim 1, further comprising determining, by the processor, availability information regarding the one or more additional users to invite to the conversation, wherein at least a portion of the notification is based upon the availability information.

3. The method of claim 2, wherein determining the availability information comprises determining availability information comprising information indicating current activity status for the one or more additional users and information indicating whether the one or more additional users are interruptible.

4. The method of claim 1, wherein analyzing the conversation information comprises:
performing, by the processor, a speech to text translation of at least a portion of the conversation information to produce translated conversation text;
identifying, by the processor, one or more keywords within the translated conversation text; and
determining, by the processor, the one or more additional users to invite to the conversation based upon the one or more keywords.

5. The method of claim 4, wherein identifying the one or more keywords comprises identifying one or more of an individual user being discussed, a group of users being discussed, or a subject matter of interest being discussed.

6. The method of claim 1, further comprising:
receiving, by the processor, subscription information from the one or more additional users, the subscription information comprising one or more subject matter keywords;
identifying, by the processor, one or more conversation keywords based upon analysis of the conversation information; and
comparing, by the processor, the one or more conversation keywords to the one or more subject matter keywords of the subscription information.

7. The method of claim 6, further comprising sending, by the processor, a subscription notification to at least one of the one or more additional users when at least one of the one or more conversation keywords matches at least one of the one or more subject matter keywords of the subscription information.

8. A computing device configured to provide an intelligent invitation system for a network-based conversation application, the computing device comprising:
a computer readable memory;
a network interface; and
at least one processor operably coupled to the memory and the network interface and configured to:
receive conversation information related to a conversation between a plurality of conversation participants,
analyze the conversation information to identify one or more additional users to invite to the conversation,
generate a notification to at least one of the plurality of conversation participants, the notification comprising information related to the one or more additional users to invite to the conversation, and
transmit the notification to one or more of the at least one of the plurality of conversation participants and the one or more additional users.

9. The computing device of claim 8, wherein the at least one processor is further configured to determine availability information regarding the one or more additional users to invite to the conversation, wherein at least a portion of the notification is based upon the availability information.

10. The computing device of claim 9, wherein the at least one processor being configured to determine the availability information comprises the at least one processor being configured to determine availability information comprising information indicating current activity status for the one or more additional users and information indicating whether the one or more additional users are interruptible.

11. The computing device of claim 8, wherein the at least one processor being configured to analyze the conversation information comprises the at least one processor being configured to:
perform a speech to text translation of at least a portion of the conversation information to produce translated conversation text;
identify one or more keywords within the translated conversation text; and
determine the one or more additional users to invite to the conversation based upon the one or more keywords.

12. The computing device of claim 11, wherein the at least one processor being configured to identify the one or more keywords comprises the at least one processor being configured to identify one or more of an individual user being discussed, a group of users being discussed, or a subject matter of interest being discussed.

13. The computing device of claim 8, wherein the at least one processor is further configured to:
receive subscription information from the one or more additional users, the subscription information comprising one or more subject matter keywords;
identify one or more conversation keywords based upon analysis of the conversation information;
compare the one or more conversation keywords to the one or more subject matter keywords of the subscription information; and
send a subscription notification to at least one of the one or more additional users when at least one of the one or more conversation keywords matches at least one of the one or more subject matter keywords of the subscription information.

14. The computing device of claim 8, wherein the at least one processor being configured to analyze the conversation information comprises the at least one processor being configured to:
perform a speech to text translation of at least a portion of the conversation information to produce translated conversation text;
input the translated conversation text to a language model to generate a modeled conversation output; and
determine the one or more additional users to invite to the conversation based upon the modeled conversation output.

15. A system configured to provide an intelligent invitation system for a network-based conversation application, the system comprising:
a computer readable memory;
a network interface operably coupled to a plurality of client computing devices; and
at least one processor operably coupled to the memory and the network interface and configured to:
receive subscription information from at least one of the plurality of client computing devices,
receive conversation information related to a conversation between a plurality of conversation participants,
analyze the conversation information to generate analyzed conversation information,
identify one or more conversation keywords based upon the analyzed conversation information,
compare the one or more conversation keywords to the one or more subject matter keywords of the subscription information, and
send a subscription notification to the at least one of the plurality of client computing devices when at least one of the one or more conversation keywords matches at least one of the one or more subject matter keywords of the subscription information.

16. The system of claim 15, wherein the at least one processor being configured to analyze the conversation information comprises the at least one processor being configured to:
perform a speech to text translation of at least a portion of the conversation information to produce translated conversation text; and
identify the one or more conversation keywords within the translated conversation text.

17. The system of claim 16, wherein the at least one processor being configured to identify the one or more conversation keywords comprises the at least one processor being configured to identify one or more of an individual user being discussed, a group of users being discussed, or a subject matter of interest being discussed.

18. The system of claim 15, wherein the at least one processor is further configured to:
analyze the conversation information to identify one or more additional users to invite to the conversation;
generate an invitation notification to at least one of the plurality of conversation participants, the invitation notification comprising information related to the one or more additional users to invite to the conversation; and
transmit the invitation notification to one or more of the at least one of the plurality of conversation participants and the one or more additional users.

19. The system of claim 18, wherein the at least one processor is further configured to determine availability information regarding the one or more additional users to invite to the conversation, wherein at least a portion of the invitation notification is based upon the availability information.

20. The system of claim 19, wherein the at least one processor being configured to determine the availability information comprises the at least one processor being configured to determine availability information comprising information indicating current activity status for the one or more additional users and information indicating whether the one or more additional users are interruptible.
